(19) United States
(12) Patent Application Publication
(10) Pub. No.: US 2007/0284009 A1
(43) Pub. Date: Dec. 13, 2007

(54) Bursting Diaphragm Arrangement

(75) Inventors: Armin Golucke, Iserlohn (DE); Michael Sickelmann, Kornwestheim (DE); Peter-Otto Wehberg, Ludenscheid (DE)

Correspondence Address: FOLEY AND LARDNER LLP;SUITE 500, 3000 K STREET NW, WASHINGTON, DC, 20007, US

(73) Assignee: BEHR GmbH & CO. KG

(21) Appl. No.: 11/659,496

(22) PCT Filed: Jul. 11, 2005
(86) PCT No.: PCT/EP05/07497

§ 371 Date: Jul. 30, 2007

(30) Foreign Application Priority Data
Aug. 9, 2004 (DE) 10 2004 038 789.3

(51) Int. Cl. F16K 17/40

(52) U.S. Cl. 137/797

(57) ABSTRACT

The inventive bursting diaphragm arrangement (B) for components and/or containers subjected to the action of internal pressure, particularly for use in mobile R744 refrigerant circuits in vehicles, comprises a housing (1) with a sealing seat (4), which is surrounded by a collar (3) and which serves to hold a bursting film (5) connected in a fluid-tight manner to the housing (1), and comprises a holding element (6) for holding the bursting film (5) on the sealing seat (4) of the housing (1). The housing (1) is open to the exterior, and the holding element (6) is formed by a disk with a central borehole. According to the invention, the holding element (6) is pressed onto the bursting film (5) by a plastic deformation of the collar (3).

The invention relates to a bursting diaphragm arrangement for components and/or containers subjected to the action of internal pressure, particularly for use in mobile R744 refrigerant circuits in vehicles.

In containers which are subjected to the action of internal pressure under operating conditions, such as for example components of refrigerant circuits in air-conditioning systems, bursting diaphragms are often used as safety elements.

The bursting diaphragms have the task of protecting the high-pressure part and the low-pressure part of the air-conditioning system from pressures exceeding the maximum allowed. As a result of the properties of the material of the bursting films, this can only take place in dependence on the temperature.

The changing internal pressure loads occurring in the refrigerant circuit must be withstood over the entire operating time or service life of the vehicle, without the bursting film suffering from fatigue. For this purpose, the latter must be correspondingly designed or processed or treated.

Conventional bursting diaphragms comprise a housing and a bursting film connected in a media-tight manner to the housing. For this purpose, the bursting film is firmly welded to the housing of the bursting diaphragm. A weldable, corrosion-resistant metal is usually used as the material for the bursting film.

On account of the corrosion resistance of the material used, no additional protection of the bursting film has to be provided against corrosive media such as splash water or salt water. The disadvantage of these materials lies in the relatively great temperature dependence of their breaking stress, as a result of which the nominal response pressure of these bursting diaphragms greatly increases with decreasing temperature. The bursting diaphragms are expensive to produce. There is also the problem of ensuring adequate process reliability in mass production. In particular, the welding operation has adverse effects on the material properties, for example the strength, of the bursting film. This must be taken into account in the design and dimensioning.

Hollow bolts with cross boreholes in the head are usually used as housings for the bursting diaphragms. The bursting films are welded into these hollow bolts. The cross boreholes in the head of the hollow bolts serve the purpose of blowing out the refrigerant when the bursting diaphragm responds to a pressure exceeding a predetermined level and bursts.

The temperature sensitivity of the material used for the bursting film and the amount of heat introduced by the welded attachment make the bursting diaphragms sensitive to changes in internal pressure, as a result of which premature material fatigue may occur. There are already indications that some of these types of bursting diaphragm that have so far been used fail after a certain number of operating hours, presumably because of fatigue of the material of the bursting film caused by changing pressure loads.

The strong temperature dependence of the response pressure of the bursting film is disadvantageous for the design and use of such bursting diaphragms as safety elements in refrigerant circuits.

In addition, there is no possible way of allowing service personnel to check visually from the outside whether a bursting diaphragm has already responded.

DE 33 39 250 A1 discloses a similar bursting diaphragm arrangement for installation as a subassembly in a pressure relieving device for closed pressure containers and the like, which is characterized by a substantially tubular basic body, which has at one end a counter borehole which forms within the basic body an annular seat for receiving at least the outer peripheral region of the bursting diaphragm, a bolt with a longitudinal borehole, which is arranged inside the counter borehole and keeps the bursting diaphragm in contact with the seat, and means by which the bolt is prevented from turning with respect to the tubular basic body, in order to keep the bursting diaphragm free or virtually free from twisting loads acting in the circumferential direction.

In the case of the solution according to DE 33 39 250 A1, the bursting film is not welded into the basic body but is firmly clamped by a bolt, which is not screwed into the basic body in order to prevent damage to the bursting diaphragm. The geometry of the bolt is very complicated and therefore cost-intensive. Visual checking of the bursting diaphragm from the outside is also not possible in the case of this solution, since only lateral cross boreholes for venting are provided in the basic body.

In the R744 refrigerant circuit, there must be protection against the maximum operating pressures being exceeded on the high-pressure and low-pressure sides. The standard with which this must comply, SAE J639, also provides that the high-pressure and low-pressure safety devices must be clearly identifiable to prevent confusion. For this purpose, the bursting diaphragms must be marked red on the high-pressure side and blue on the low-pressure side, which is difficult to implement in the case of the hollow metal bolts currently being used.

On account of the small margin from the maximum operating pressure and the maximum permissible pressures in the R744 refrigerant circuit, it is only possible under some conditions for blow-off valves to be technically realized as safety elements. In particular, in principle this entails relatively high costs. Therefore, generally only bursting diaphragms are used as safety elements in R744 refrigerant circuits. Bursting diaphragms also have the advantage over safety valves of lower costs. On the other hand, the technical disadvantages of conventional bursting diaphragms as compared with valves are the temperature dependence of the nominal response pressure on account of the material behavior of the bursting film and the sensitivity to changing pressure loads, which can lead to the bursting film suffering from fatigue.

The invention is based on the object of improving a bursting diaphragm arrangement of the type mentioned at the beginning in such a way that it can be produced more easily and at lower cost and that visual checking of the state of the bursting film from the outside is made possible. A further object of the invention is that of improving the bursting diaphragm arrangement to the extent that it has a durable color marking for better distinguishability.

According to the invention, the object is achieved by a bursting diaphragm arrangement with the features of claim 1. Advantageous refinements of the invention are the subject of subclaims.

The bursting diaphragm arrangement according to the invention for components and/or containers subjected to the action of internal pressure, particularly for use in mobile R744 refrigerant circuits in vehicles, comprises a housing with a sealing seat, which is surrounded by a collar and serves for holding a bursting film, which is connected in a fluid-tight manner to the housing, and comprises a holding element for fixing the bursting film on the sealing seat of the housing, and is characterized in that the holding element is pressed onto the bursting film by plastic deformation of the collar. For example, the holding element is formed as a disk with a central borehole. The housing is expediently open to the exterior.

A bursting diaphragm arrangement formed in such a way can be produced more easily and at lower cost than known solutions. Production can be automated and is suitable for producing large numbers of items. The way in which the housing is made to be open to the exterior allows the state of the bursting film to be visually inspected at any time from the outside.

In an advantageous refinement, the material of the bursting film is nickel or a nickel alloy. On account of the material properties of nickel or the nickel alloy, a relatively low temperature dependence of the nominal response pressure is achieved.

In a further refinement, the bursting film is hardened by cold rolling. On account of this pretreatment of the material of the bursting film by deformation, its sensitivity to changing pressure loads is much lower than in the case of untreated material. On the other hand, the tolerance band increases with an increasing degree of deformation. This produces a greater reliability and longer service life of the bursting diaphragm arrangement.

It has proven to be particularly advantageous if the degree of deformation of the pretreatment lies in a range of below 0 to −0.4, i.e. that the thickness of the material is reduced during the pretreatment. The degree of deformation φ is defined as the natural logarithm of the quotient of the undeformed length or thickness t and the initial length or thickness t₀, expressed as a formula:

$$φ = ln ( \frac{t}{{t}_{0}} )$$

In a further, advantageous development, a colored, in particular single-colored or multi-colored, protective cap of corrosion-resistant and/or temperature-resistant material is provided. The necessary protection of the bursting film from splash water and dust is achieved by the protective cap. The protective cap is made in many variants, without deviating from the basic concept of the invention.

The protective cap performs a number of functions, namely protection of the bursting film from splash water and dust, and with the colored identification of the safety device a simple visual check as to whether the bursting diaphragm has responded.

In an advantageous refinement, the protective cap is integrated in the housing of the bursting diaphragm arrangement. This produces advantages with regard to the ease of handling of the bursting diaphragm arrangement.

On the other hand, the use of a separate protective cap makes it possible to separate the two functions, protection against excessive pressure and protection of the bursting film against harmful external influences such as dust and splash water, in particular when the bursting diaphragm arrangement is used in the engine compartment of a vehicle. As a result, a flexible design of the two components is possible with regard to the materials used, the design possibilities of the housing of the bursting diaphragm arrangement and the protective cap.

In an advantageous refinement of the invention, the protective cap has a substantially hollow-cylindrical basic body which is closed on one side by a base and has an external thread, the base comprising a predetermined breaking point in the form of a peripheral groove.

The protective cap is advantageously locally reinforced in the base, in particular in the region of the peripheral groove. When the protective cap is subjected to pressure as a result of destruction of the bursting diaphragm, the base of the protective cap can swing away, since the reinforcement acts in the manner of a hinged joint. As a result, the base is not completely detached from the protective cap.

Particularly advantageously, the protective cap has means for screwing into and unscrewing from a threaded borehole. As a result, the fitting and removal of the protective cap is made easier.

With preference, the means for screwing in and unscrewing is an internal hexagon arranged in the interior of the hollow-cylindrical basic body.

Preferably, the means for screwing in and unscrewing is an external hexagon arranged on the outer side of the hollow-cylindrical basic body.

Exemplary embodiments of the invention are explained in more detail on the basis of a drawing, in which:

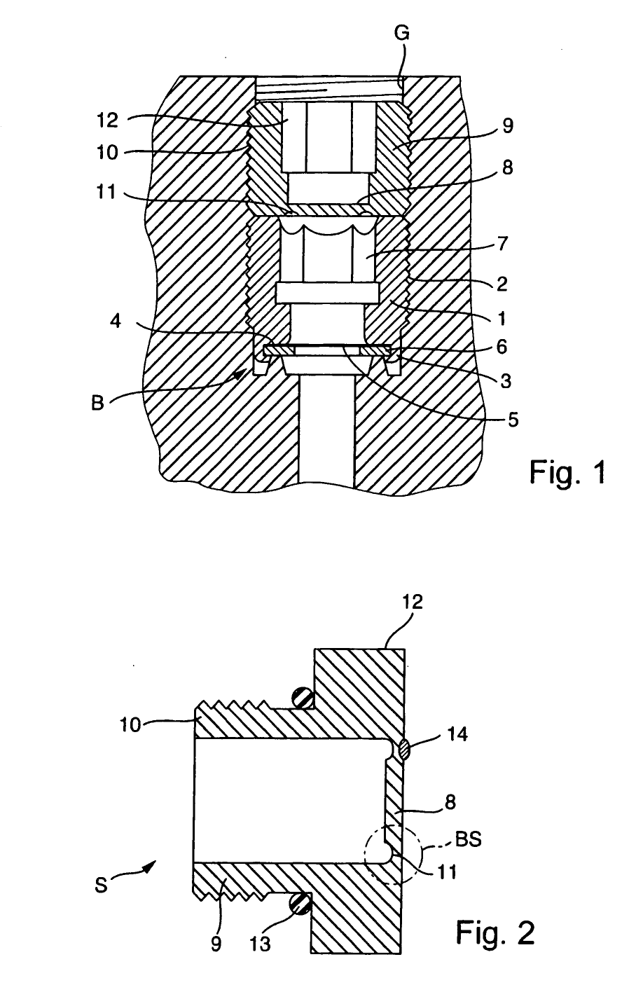

FIG. 1 shows a bursting diaphragm arrangement according to the invention with a protective cap, and

FIG. 2 shows an alternative embodiment of a protective cap according to the invention.

Parts corresponding to one another are provided with the same designations in all the figures.

Represented in FIG. 1 is a bursting diaphragm arrangement B, which is screwed into a threaded borehole G provided for this purpose in a pressurized container, for example in a component of a vehicle air-conditioning system that is subjected to the action of internal pressure.

The bursting diaphragm arrangement B comprises a substantially hollow-cylindrical housing 1 with an external thread 2 and a sealing seat 4, which is surrounded by a collar 3 and serves for holding a bursting film 5, comprises a bursting film 5, which is connected in a fluid-tight manner to the housing 1, and comprises a holding element 6 for fixing the bursting film 5 on the sealing seat 4 of the housing 1. The bursting film is produced from nickel and is hardened by cold rolling before being fitted into the bursting diaphragm arrangement B.

The housing 1 is open to the exterior. In the interior of the hollow-cylindrical housing 1, a screwing-in and unscrewing means 7, formed for example as an internal hexagon, is provided for screwing in and unscrewing the housing 1.

The holding element 6 is a disk with a central borehole, which is pressed onto the bursting film 5 by plastic deformation of the collar 3. As a result, the bursting diaphragm arrangement B is fluid-tight in the intact state.

Furthermore, the bursting diaphragm arrangement B comprises a colored, in particular multi-colored or single-colored, protective cap S of corrosion-resistant material, which has a substantially hollow-cylindrical basic body 9, which is closed on one side by a base 8 and has an external thread 10, the base 8 having a predetermined breaking point BS in the form of a peripheral groove 11. As a result, the protective cap S can be screwed into the same threaded borehole G as the housing 1 if the two external threads 2, 10 are given the same dimensions.

The protective cap S has means 12 for screwing into and unscrewing from the threaded borehole G, which in the exemplary embodiment is an internal hexagon arranged in the interior of the hollow-cylindrical basic body 9.

If the pressure in the container rises above the maximum allowed pressure, the bursting film 5 bursts, so that the internal pressure of the container bears against the base 8 of the protective cap S. The peripheral groove 11 on the base 8 of the basic body 9 cannot withstand this pressure and likewise bursts, so that the content of the container can escape. As a result, the interior space of the container is relieved, so that the container cannot be damaged by the excess pressure. At the same time, the bursting of the base 8 of the protective cap S makes visual checking of the state of the bursting diaphragm arrangement B possible on the basis of the colored identification, so that the service personnel can detect from the outside that the bursting film 5 has responded.

Represented in FIG. 2 is an alternative embodiment of the protective cap S, which likewise consists of colored, corrosion-resistant material and has a substantially hollow-cylindrical basic body 9 which is closed on one side by a base 8 and has an external thread 10. In addition, the base 8 is provided with a predetermined breaking point BS in the form of a peripheral groove 11. As a result, the protective cap S can be screwed into the same threaded borehole G as the housing 1 if the two external threads 2, 10 are given the same dimensions.

The protective cap S is provided in the region of the peripheral groove 11 with a local reinforcement 14. When the protective cap S is subjected to pressure as a result of destruction of the bursting film 5, the base 8 of the protective cap S can swing away, since the reinforcement 14 acts in the manner of a hinged joint. As a result, the base 8 is not completely detached from the protective cap S. The reinforcement 14 may be subsequently applied or formed in one piece with the protective cap S, for example be molded onto the latter.

The protective cap S has a means 12 for screwing into it and unscrewing from the threaded borehole G, which in the exemplary embodiment is an external hexagon arranged on the outer side of the hollow-cylindrical basic body 9. Provided underneath the external hexagon is a sealing means 13, which in the exemplary embodiment is in the form of an O-ring.

1. A bursting diaphragm arrangement for components and or containers subjected to the action of internal pressure, particularly for use in mobile R744 refrigerant circuits in vehicles, comprising a housing with a sealing seat, which is surrounded by a collar and serves for holding a bursting film, which is connected in a fluid-tight manner to the housing, and comprises a holding element for fixing the bursting film on the sealing seat of the housing, wherein the holding element is pressed onto the bursting film by plastic deformation of the collar.

2. The bursting diaphragm arrangement as claimed in claim 1, wherein the material of the bursting film is nickel or a nickel alloy.

3. The bursting diaphragm arrangement as claimed in claim 1, wherein the material of the bursting film is pretreated by cold rolling for hardening.

4. The bursting diaphragm arrangement as claimed in claim 3, wherein the degree of deformation of the pretreatment lies in the range of 0 to −0.4.

5. The bursting diaphragm arrangement as claimed in claim 1, wherein a colored protective cap of corrosion-resistant and/or temperature-resistant material is provided.

6. The bursting diaphragm arrangement as claimed in claim 5, wherein the protective cap is integrated in the housing.

7. The bursting diaphragm arrangement as claimed in claim 5, wherein the protective cap has a substantially hollow-cylindrical basic body which is closed on one side by a base and has an external thread, the base comprising a predetermined breaking point in the form of a peripheral groove.

8. The bursting diaphragm arrangement as claimed in claim 5, wherein the protective cap has a locally confined reinforcement in the base, in particular in the region of the peripheral groove.

9. The bursting diaphragm arrangement as claimed in claim 8, wherein the protective cap has a means for screwing into and unscrewing from a threaded borehole.

10. The bursting diaphragm arrangement as claimed in claim 9, wherein the means for screwing in and unscrewing is an internal hexagon arranged in the interior of the hollow-cylindrical basic body.

11. The bursting diaphragm arrangement as claimed in claim 8, wherein the means for screwing in and unscrewing is an external hexagon arranged on the outer side of the hollow-cylindrical basic body.

12. The bursting diaphragm arrangement as claimed in claim 2, wherein the material of the bursting film is pretreated by cold rolling for hardening.

13. The bursting diaphragm arrangement as claimed in claim 2, wherein a colored protective cap of corrosion-resistant and/or temperature-resistant material is provided.

14. The bursting diaphragm arrangement as claimed in claim 3, wherein a colored protective cap of corrosion-resistant and/or temperature-resistant material is provided.

15. The bursting diaphragm arrangement as claimed in claim 4, wherein a colored protective cap of corrosion-resistant and/or temperature-resistant material is provided.

16. The bursting diaphragm arrangement as claimed in claim 6, wherein the protective cap has a substantially hollow-cylindrical basic body which is closed on one side by a base and has an external thread, the base comprising a predetermined breaking point in the form of a peripheral groove.

17. The bursting diaphragm arrangement as claimed in claim 6, wherein the protective cap has a locally confined reinforcement in the base, in particular in the region of the peripheral groove.

18. The bursting diaphragm arrangement as claimed in claim 7, wherein the protective cap has a locally confined reinforcement in the base, in particular in the region of the peripheral groove.
